(19) United States
(12) Patent Application Publication
(10) Pub. No.: US 2021/0073662 A1
(43) Pub. Date: Mar. 11, 2021

(54) Machine Learning Systems and Methods for Performing Entity Resolution Using a Flexible Minimum Weight Set Packing Framework

(71) Applicant: Insurance Services Office, Inc., Jersey City, NJ (US)

(72) Inventors: Vishnu Sai Rao Suresh Lokhande, Madison, WI (US); Shaofei Wang, Philadephia, PA (US); Maneesh Kumar Singh, Lawrenceville, NJ (US); Julian Yarkony, Jersey City, NJ (US)

(73) Assignee: Insurance Services Office, Inc., Jersey City, NJ (US)

(21) Appl. No.: 17/018,552

(22) Filed: Sep. 11, 2020

Related U.S. Application Data
(60) Provisional application No. 62/898,681, filed on Sep. 11, 2019.

(51) Int. Cl. G06N 5/04; G06N 20/00

(52) U.S. Cl. CPC G06N 5/04; G06N 20/00

(57) ABSTRACT

Machine learning systems and methods for performing entity resolution. The system receives a dataset of observations and utilizes a machine learning algorithm to apply a blocking technique to the dataset to identify and generate a subset of pairs of observations of the dataset that could represent a same real world entity. The system generates a probability score for each pair of observations of the subset where the probability score is defined over a given pair of observations and denotes a probability that each pair is associated with a common entity in ground truth. The system utilizes a flexible minimum weight set packing framework to determine problem specific cost terms of a single hypothesis associated with the subset of pairs of observations and to perform entity resolution by partitioning the subset of pairs of observations into hypotheses based on the cost terms.

### RELATED APPLICATIONS

This application claims priority to U.S. Provisional Patent Application Ser. No. 62/898,681 filed on Sep. 11, 2019, the entire disclosure of which is hereby expressly incorporated by reference.

### BACKGROUND

### Technical Field

The present disclosure relates generally to the field of machine learning technology. More specifically, the present disclosure relates to machine learning systems and methods for performing entity resolution using a flexible minimum weight set packing framework.

### Related Art

In the field of machine learning, entity resolution is the task of disambiguating records that correspond to real world entities across and within datasets. Entity resolution can be described as recognizing when two observations relate to the same entity despite having been described differently (e.g., duplicates of the same person with different names in an address book) or recognizing when two observations do not relate to the same entity despite having been described similarly (e.g., two same names where the first has a Jr. suffix and the second has a Sr. suffix). Entity resolution also relates to the ability to remember the relationship between these entities. The applications of entity resolution can be vast for the public sector and federal datasets related to banking, healthcare, insurance, transportation, finance, law enforcement, and the military.

As the volume and velocity of data grows, inference across networks and semantic relationships between entities becomes a greater challenge. Entity resolution can reduce this complexity by de-duplicating and linking entities. Traditional approaches tackle entity resolution with hierarchical clustering. However, these approaches do not benefit from a formal optimization formulation. Thus, these approaches are heuristic and inexact and could benefit from a formal optimization formulation.

Therefore, there is a need for computer systems and methods which can perform entity resolution using an optimized formulation, thereby improving speed and utilizing fewer computational resources. These and other needs are addressed by the machine learning systems and methods of the present disclosure.

### SUMMARY

The present disclosure relates to machine learning systems and methods for performing entity resolution using a flexible minimum weight set packing framework. The system uses attributes of a table to determine if two observations represent the same real world entity. Specifically, pair identification is performed such that pairs are selected in a high recall-low precision region of a precision-recall curve. This serves to eliminate the overwhelming majority of bad matches while keeping the possible good matches, and exploits the fact that the number of false matches is significantly greater than the number of true matches in entity resolution problems. More specifically, the system first generates a limited set of pairs of observations. The each set of pairs of observations may be co-assigned in a hypothesis. The system then generates a probability score for each pair of observations. The probability score is defined over a given pair of observations which is the probability that the pair is associated with a common entity in ground truth. The system then defines problem specific cost terms of a single hypothesis cost terms associated with pairs of possible co-associate observations. For example, the system can generate cost terms by adding a bias to negative of probability scores. The system then determines a negative (or lowest) reduced cost of the hypothesis (which can be referred to as “pricing”). The system then performs entity resolution using a F-MWSP formulation. Specifically, using the F-MWSP formulation, the system packs observations into a hypotheses based on the cost terms. This generates a bijection from the hypothesis in the packing to real world entities.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating overall system of the present disclosure;

FIG. 2A is a flowchart illustrating the overall process steps being carried out by the system of the present disclosure;

FIG. 2B is a flowchart illustrating step 36 of FIG. 2A in greater detail;

FIG. 3 shows an example algorithm for a solving minimum weight set packing (“MWSP”) problem via column generation in connection to the system of the present disclosure;

FIG. 4 is a flowchart illustrating step 44 of FIG. 2B in greater detail;

FIG. 5 is a table showing a comparison between the hierarchical clustering and the Flexible-MWSP (“F-MWSP”) framework of the present disclosure;

FIG. 6 is a table showing dataset statistics of the different datasets used in experiments in connection with the system of the present disclosure;

FIG. 7 is a graph showing speedups using the flexible dual optimal inequalities of the system of the present disclosure;

FIG. 8 is a table showing results of the F-MWSP formulation of the present disclosure compared to prior art baselines on two benchmark datasets; and

FIG. 9 is a diagram illustrating sample hardware and software components capable of being used to implement the system of the present disclosure.

### DETAILED DESCRIPTION

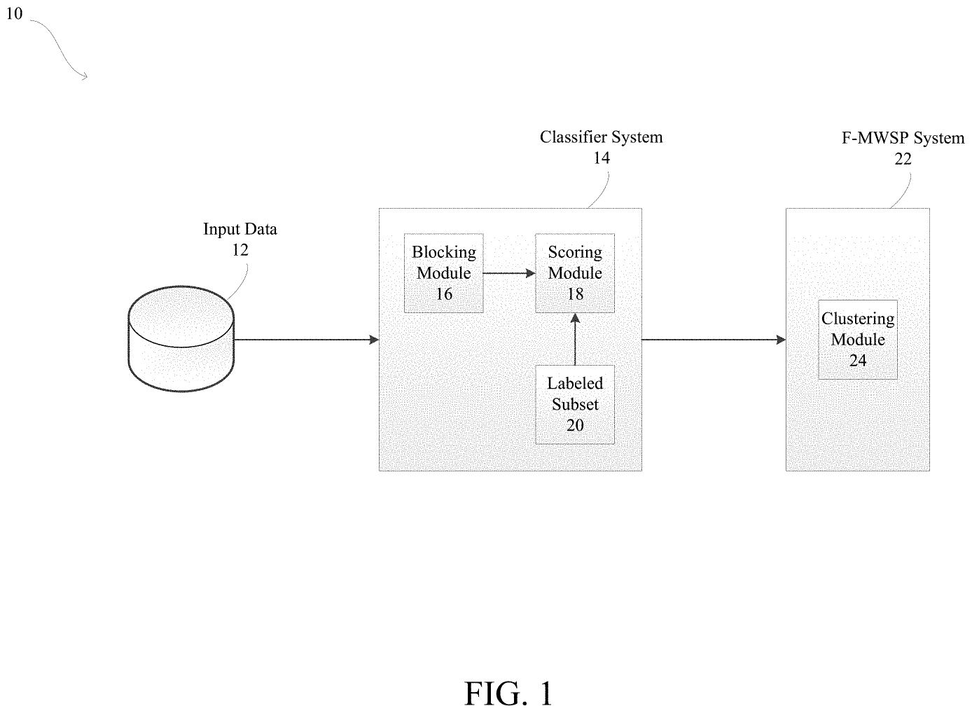

The present disclosure relates to machine learning systems and methods for performing entity resolution using a flexible minimum weight set packing framework, as described in detail below in connection with FIGS. 1-9.

The present system describes an optimized approach to entity resolution. Specifically, the present system models entity resolution as correlation-clustering, which the present system treats as a weighted set-packing problem and denotes as an integer linear program (“ILP”). Sources in the input data correspond to elements, and entities in output data correspond to sets/clusters. As will be described in greater detail below, the present system performs optimization of weighted set packing by relaxing integrality in an ILP formulation. Since the set of potential sets/clusters cannot be explicitly enumerated, the present system performs optimization using column generation. In addition, the present system generates flexible dual optimal inequalities (“F-DOIs”) which tightly lower-bound dual variables during optimization and accelerate the column generation. The system applies this formulation to entity resolution to achieve improved accuracy and increase speed using fewer computational resources when processing input data (e.g., datasets).

FIG. 1 is a diagram illustrating the system of the present disclosure, indicated generally at 10. The system 10 includes a classifier system 14 which receives input data 12, and a flexible minimum weight set packing (“F-MWSP”) system 22. The input data 12 can include a dataset of observations, each observation associated with up to one object. The dataset of observations can be referred to as records, where each record is associated with a subset of fields, such as, for example, a name, a social security number, a phone number, etc.

The classifier system 14 includes a blocking module 16, a scoring module 18, and a labeled subset 20. The blocking module applies a blocking technique to the input data 12, which generates a limited set of pairs of observations which can be co-assigned in a common hypotheses. The scoring module 18 generates a probability score for each pair of observations. The scoring module can be trained by a learning algorithm using the labeled subset 20 to distinguish between observation pairs that are/are not part of a common entity in ground truth (information provided by direct observation as opposed to by inference). This will be explained in greater detail below.

The classifier system 14 generates output data that is fed into the F-MWSP system 22. The F-MWSP system 22 includes a clustering system 24 and processes the output data to generate hypotheses. Specifically, given input data (e.g., a dataset of observations each associated with up to one object), the system 10 packs (or partitions) the observations into groups called hypothesis (or entities) such that there is a bijection from the hypotheses to unique entities in the dataset. The system 10 partitions the observations into the hypothesis so that: (1) all observations of any real world entity are associated with exactly one selected hypothesis; and (2) each selected hypothesis is associated with observations of exactly one real world entity. The processes of the F-MWSP system 22 will be explained in greater detail below.

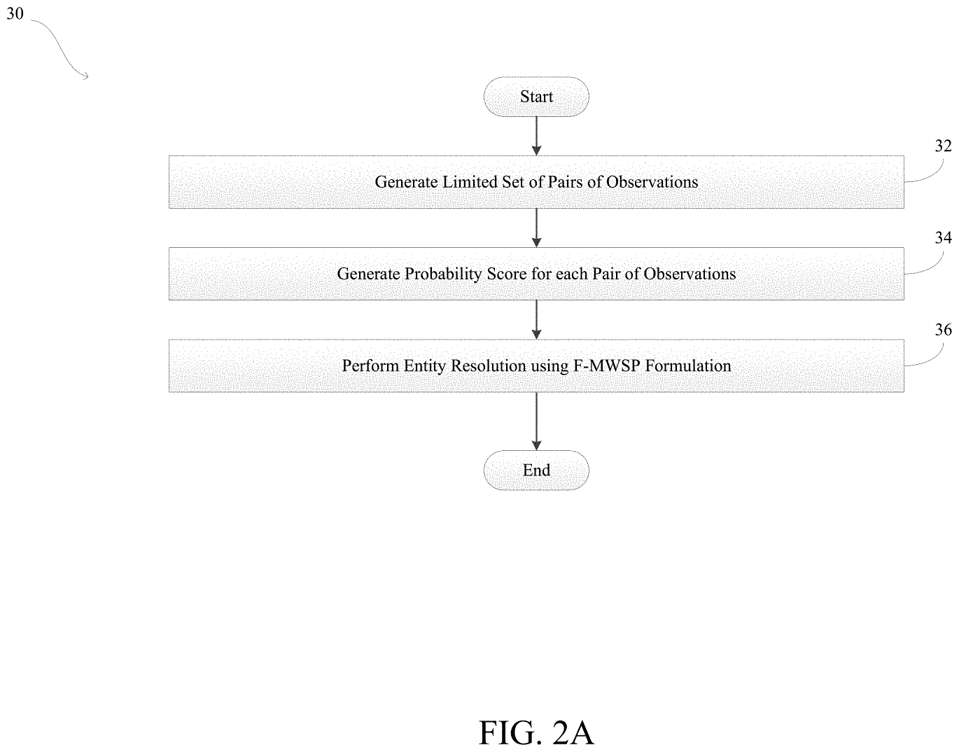

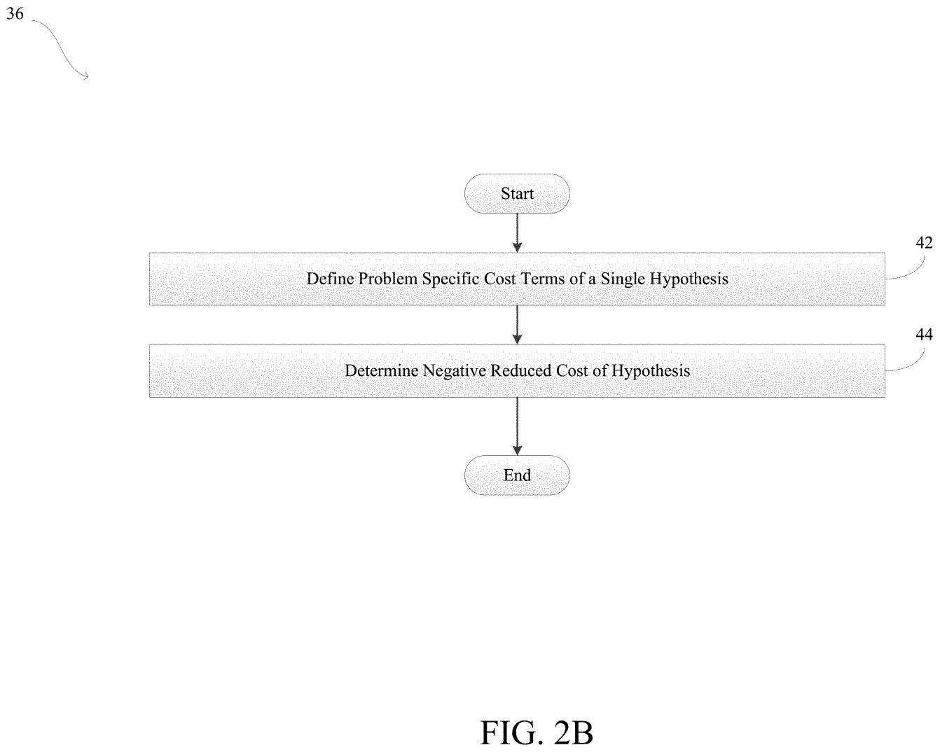

FIG. 2A is a flowchart illustrating the overall process steps being carried out by the system 10, indicated generally at method 30. It is first noted that entity resolution seeks to construct a surjection from observations in input dataset to real world entities. The observations in the dataset are denoted [symbol] . Specifically, the dataset consists of a structured table where each row (or tuple) represents an observation of a real world entity. The system 10 uses the attributes of the table to determine if two observations represent the same real world entity. Specifically, the system 10 uses a blocking technique in which the classifier system 14 uses a set of pre-defined, fast-to-run predicates to identify a subset of pairs of observations which could conceivably correspond to common entities (thus blocking operates in a high recall regime).

In step 32, the system 10 generates a limited set of pairs of observations. The each set of pairs of observations may be co-assigned in a hypothesis. In an example, the blocking module 16 filters out a portion of pairs of observations from the input data 12. This leaves a proportion of the pairs for further processing.

In step 34, the system 10 generate a probability score for each pair of observations using the scoring module 18. The probability score is defined over a given pair of observations which is the probability that the pair is associated with a common entity in ground truth. As discussed above, the scoring module can be trained to distinguish by any learning algorithm on annotated data (e.g., the labeled data 20) to generate the probability scores.

In step 36, the system 10 performs entity resolution using a F-MWSP formulation. Specifically, using the F-MWSP formulation, the system 10 packs observations into a hypothesis based on the cost terms. This generates a bijection from the hypothesis in the packing to real world entities. Step 36 will be explained in further detail below with respect to FIG. 2B.

FIG. 2B is a flowchart illustrating step 36 of FIG. 2A in greater detail. In step 42, the system 10 defines problem specific cost terms of a single hypothesis. For example, the system 10 can generate cost terms by adding a bias to negative of probability scores. The system 10 defines the cost terms of the hypothesis as follows. First, the system 10 considers a set of observations [symbol] , where for any d₁∈ [symbol] , d₂∈ [symbol] that θ_{d1d2}∈ [symbol] is the cost associated with including d₁, d₂ in a common hypothesis. Here, positive/negative values of θ_{d1d2} discourage/encourage d₁, d₂ to be associated with a common hypothesis. The magnitude of θ_{d1d2} describes the degree of discouragement/encouragement. The system 10 assumes without loss of generality that θ_{d1d2}=θ_{d2d1}. The system 10 constructs θ_{d1d2} from an output classifier as (0.5−p_{d1d2}) where p_{d1d2} is the probability provided by the classifier system 14 that d₁, d₂ are associated with the common hypothesis in the ground truth.

The system 10 defines the cost of the hypothesis g \ in G, the set of all possible hypotheses. The term G is described using matrix G∈ [symbol] . G_{dg}=1 if the hypothesis g includes observation d, and otherwise G_{dg}=0. It is a structural property of the problem domain that most pairs of observations cannot be part of the common hypothesis. For such pairs, d₁, d₂ then θ_{d1d2}=∞. These are the pairs not identified by the blocking module 16 as being feasible. The system 10 uses θ_{dd}=0 for all d∈ [symbol] . The system 10 defines the cost of the hypothesis g∈G as shown in Equation 1, below:

$${Γ}_{g} = {\sum }_{{{d}_{1} ∈ 𝒟}_{{d}_{2} ∈ 𝒟}} {θ}_{{d}_{1} {d}_{2}} {G}_{{d}_{1} g} {G}_{{d}_{2} g} \qquad Equation 1$$

With the cost of the hypothesis defined, the system 10 can treat entity resolution as a MWSP (minimum weight set packing) problem, and solve it using column generation. Any observation not associated with any selected hypothesis in the solution to the MWSP problem is defined to be in a hypothesis by itself of zero cost.

The following will discuss an integer literal program (“ILP”) formulation of the MWSP problem. An observation corresponds to an element in a set-packing context and a data source in the entity resolution context. Term [symbol] is used to denote a set of observations, which are index by term d. A hypothesis corresponds to a set in the set-packing context, and an entity in the entity resolution context. Given a set of observations [symbol] , the set of all hypotheses is the power set of [symbol] , which is denoted as term G and index by term g.

A real valued cost Γ_{g} is associated to each g∈G, where Γ_{g} is the cost of including g in the packing. The hypothesis g containing no observations is defined to have cost Γ_{g}=0. A packing is described using γ∈{0, 1}^{|G|} where γ_{g}=1 indicates that the hypothesis g is included in the solution, and otherwise γ_{g}=0. Thus, MWSP problem written as an ILP is expressed by Equation 2, below:

$$\begin{matrix}{min}_{γ ∈ {\{ 0 , 1 \}}^{\vert 𝒢 \vert}} {\sum }_{g ∈ 𝒢} {Γ}_{g} {γ}_{g} & Equation 2 \\ s . t . {\sum }_{g ∈ 𝒢} {G}_{d g} {γ}_{g} \leq 1 ∀ d ∈ 𝒟 & \end{matrix}$$

The constraints in Equation 2 enforce that no observation is included in more than one selected hypothesis in the packing. Solving Equation 2 is challenging for two key reasons. First, MWSP is NP-hard problem. Second term G is too large to be considered in optimization. To tackle the first key reason, the system 10 relaxes the integrality constraints on γ, resulting in a linear problem expressed by Equation 3, below:

$$\begin{matrix}Eq 2 \geq {min}_{γ \geq 0} {\sum }_{g ∈ 𝒢} {Γ}_{g} {γ}_{g} & Equation 3 \\ s . t . {\sum }_{g ∈ 𝒢} {G}_{d g} {γ}_{g} \leq 1 ∀ d ∈ 𝒟 & \end{matrix}$$

The system 10 can circumvent the second key reason using column generation. Specifically, a column generation algorithm constructs a small sufficient subset of G (which is denoted Ĝ and initialized empty), subject to an optimal solution to Equation 3 exists for which only hypothesis in Ĝ are used. Thus, column generation avoids explicitly enumerating term G, which grows exponentially in term |D|. Primal-dual optimization over Ĝ, which is referred to as the restricted master problem (“RMP”), is expressed by Equations 4 and 5, below:

$$\begin{matrix}{min}_{γ \geq 0} {\sum }_{g ∈ \hat{𝒢}} {Γ}_{g} {γ}_{g} \\ s . t . {\sum }_{g ∈ \hat{𝒢}} {G}_{d g} {γ}_{g} \leq 1 ∀ d ∈ 𝒟 & Equation 4 \\ = {max}_{λ \leq 0} {\sum }_{d ∈ 𝒟} {λ}_{d} \\ s . t . {Γ}_{g} - {\sum }_{d ∈ 𝒟} {G}_{d g} {λ}_{d} \geq 0 ∀ g ∈ \hat{𝒢} & \end{matrix}$$

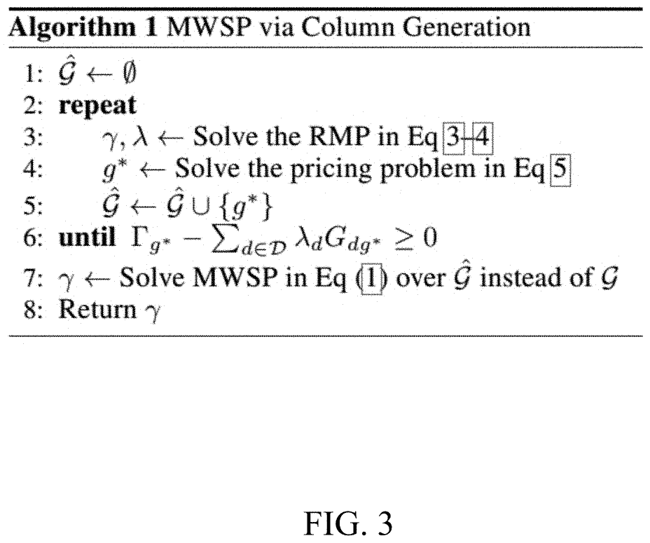

Equation 5 FIG. 3 shows an example algorithm for solving a MW SP problem via column generation. The column generation algorithm solves the MW SP problem by alternating between solving the RMP in Equation 5, above, given Ĝ (e.g., FIG. 3, line 3) and adding hypothesis in G to Ĝ, that have negative reduced cost given dual variables A (e.g., FIG. 3, line 4). Selection of the lowest reduced cost hypothesis in G is referred to as pricing, and is expressed in Equation 6, below:

$${min}_{g ∈ 𝒢} {Γ}_{g} - {\sum }_{d ∈ 𝒟} {λ}_{d} {G}_{d g} \qquad Equation 6$$

The system 10 can solve Equation 6 using a specialized solver exploiting specific structural properties of the problem domain. In many problem domains, pricing algorithms return multiple negative reduced cost hypothesis in G. In these cases, some or all returned hypotheses with negative reduced cost are added to Ĝ.

The column generation terminates when no negative reduced cost hypotheses remain in term G (e.g., FIG. 3, line 6). The column generation does not require that the lowest reduced cost hypothesis is identified during pricing to ensure that Equation 3 is solved exactly. Rather, Equation 3 is solved as long as a g∈G with negative reduced cost is produced at each iteration of the column generation if one exists.

If Equation 4 produces a binary valued y at termination of column generation (i.e. the LP-relaxation is tight), then β is probably the optimal solution to Equation 2. However, if γ is fractional at termination of the column generation, an approximate solution to Equation 2 can be obtained by the system 10 by replacing Gin Equation 2 with Ĝ (e.g., FIG. 3, line 7). It is noted that Equation 3 describes a tight relaxation in practice, and the system 10 can tighten Equation 3 using subset-row inequalities.

The convergence of the algorithm in FIG. 3 can be accelerated by providing bounds on the dual variables in Equation 5 without altering the final solution of the algorithm, thus limiting the dual space that the algorithm searches over. The system 10 defines dual optimal inequalities (“DOI”) with Ξ_{d} which lower bounds dual variables in Equation 5 as −Ξ_{d}≤λ_{d}, ∀d∈ [symbol] . The system 10 augments the primal RMP in Equation 4 with new primal variables ξ, where primal variable ξ_{d} corresponds to the dual constraint −Ξ_{d}≤λ_{d}, which are expressed by Equation 7 and 8, below:

$$\begin{matrix}{min}_{{γ \geq 0}_{ξ \geq 0}} {Γ}_{g} {γ}_{g} + {\sum }_{d ∈ 𝒟} {Ξ}_{d} {ξ}_{d} & Equation 7 \\ s . t . - {ξ}_{d} + {G}_{d g} {γ}_{g} \leq 1 & \\ = {max}_{- {Ξ}_{d} \leq {λ}_{d} \leq 0} {\sum }_{d ∈ 𝒟} {λ}_{d} & Equation 8 \\ s . t . {Γ}_{g} - {\sum }_{d ∈ 𝒟} {G}_{d g} {λ}_{d} \geq 0 ∀ g ∈ & \end{matrix}$$

It is noted that removal of a small number of observations rarely causes a significant change to the cost of a hypothesis in Ĝ. As such, the system 10 can use varying DOIs, which will now be discussed. Term g̅(g, [symbol] ₛ) is a hypothesis consisting of g with all observations in [symbol] ₛ ⊆ [symbol] removed. Formally, G_{dg̅}(g, [symbol] ₛ)=G_{dg}[d∉ [symbol] ₛ], ∀d∈ [symbol] . The term ε is a small positive number. The system 10 computes varying DOIs using Equation 9, below:

$$\begin{matrix}{Ξ}_{d} = ϵ + {Ξ}_{d g}^{*} ∀ d ∈ 𝒟 & Equation 9 \\ {Ξ}_{d g}^{*} \geq {Γ}_{\overline{g} ( \hat{g} , \{ d \} )} - {Γ}_{\hat{g}} & \end{matrix}$$

It is noted that Ξ_{d} may increase (but not decrease) over the course of column generation as Ĝ grows. The computation of Ξ_{dg} is performed by the system 10 using problem specific worst case analysis for each g upon addition to Ĝ.

A drawback of varying DOI is that Ξ_{d} depends on all hypotheses in Ĝ(as defined in Equation 9), while often only a small subset of Ĝ are active (selected) in an optimal solution to Equation 4. Thus, during the process of the algorithm in FIG. 3, the presence of a hypothesis in Ĝ may increase the cost of the optimal solution found in current iteration, making exploration of solution space slower. Accordingly, to circumvent this difficulty, the system 10 can utilizes Flexible DOIs (F-DOIs).

The following will discuss a MWSP formulation using column generation featuring the F-DOIs. Given any g∈G, term Ξ_{dg} is positive if G_{dg}=1, otherwise, term Ξ_{dg}=0, and defined such that for all non-empty [symbol] ₛ ⊆ [symbol] the following bound expressed in Equation 10, below, is satisfied:

$${\sum }_{d ∈ {𝒟}_{s}} {Ξ}_{d g} \geq ϵ + {Γ}_{\overline{g} ( g , {𝒟}_{s} )} - {Γ}_{g} \qquad Equation 10$$

Term Z_{d} is a set of unique positive values of Ξ_{dg} over all g∈ Ĝ, which are index by term z. The system 10 orders the values in Z_{d} from smallest to largest as [ω_{d1}, ω_{d2}, ω_{d3} . . . ]. Term Ξ_{dg} is described using Z_{dzg} ∈{0, 1} where Z_{dzg}=1 if Ξ_{dg}≥ω_{dz}. Additionally, term Ξ_{dg} is described using Ξ_{dz} as follows: Ξ_{dz}=ζ_{dz}−ω_{d(z-1)} ∀z∈Z_{d}, z≥2; Ξ_{d1}=ω_{d1}. The system 10 uses term Z to model the MWSP problem as a primal/dual LP, as expressed in Equations 11 and 12, below, where the F-DOIs are inequalities −Ξ_{dz}≤λ_{dz}:

$$\begin{matrix}{min}_{{γ \geq 0}_{ξ \geq 0}} {Γ}_{g} {γ}_{g} + {\sum }_{{d ∈ 𝒟}_{z ∈ {Z}_{d}}} {Ξ}_{dz} {ξ}_{dz} & Equation 11 \\ s . t . - {ξ}_{dz} + {Z}_{dzg} {γ}_{g} \leq 1 ∀ d ∈ 𝒟 , z ∈ {Z}_{d} & \\ = {max}_{{- {Ξ}_{dz} \leq {λ}_{dz} \leq 0}_{∀ d ∈ 𝒟 , z ∈ {Z}_{d}}} {\sum }_{{d ∈ 𝒟}_{z ∈ {Z}_{d}}} {λ}_{dz} & Equation 12 \\ s . t . {Γ}_{g} - {\sum }_{{d ∈ 𝒟}_{z ∈ {Z}_{d}}} {Z}_{dzg} {λ}_{z} \geq 0 ∀ g ∈ & \end{matrix}$$

The system 10 conducts efficient pricing under the MWSP formulation of Equation 11 using Equation 13, below:

$$min g ∈ {𝒢Γ}_{g} - {\sum }_{{d ∈ 𝒟}_{z ∈ {Z}_{d}}} {Z}_{dzg} {λ}_{dz} \qquad Equation 13$$

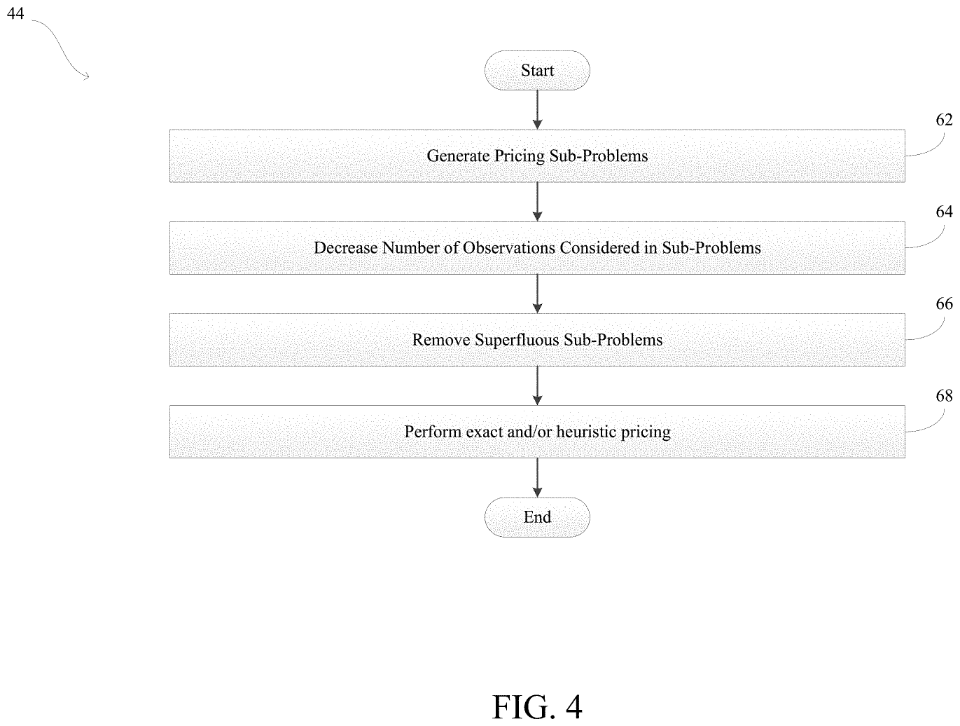

Returning to FIG. 2B, in step 44, the system 10 determines a negative (or lowest) reduced cost of the hypothesis. This step can be referred to as “pricing.” It is first noted that with hypothesis cost Γ_{g} defined in Equation 1, the system 10 can solve Equation 6. However, solving Equation 6 would be exceedingly challenging if the system 10 had to consider all d∈ [symbol] at once. To circumvent this difficulty, the system 10, for any fixed d*∈ [symbol] , solves for the lowest reduced cost hypothesis that includes d*. This is because given d*all d∈ [symbol] for which θ_{d*d}=∞ can be removed from consideration. The system 10 solving Equation 6 thus consists of solving multiple parallel pricing sub-problems, one for each d*∈ [symbol] . All negative reduced cost solutions are then added to Ĝ. This will be explained in further detail in connection with FIG. 4.

FIG. 4 is a flowchart illustrating step 44 of FIG. 2B in greater detail. In step 62, the system 10 generates a set of pricing sub-problems each defined over a subset of D. The pricing sub-problem can be expressed using Equation 14, below, given d*∈ [symbol] .

$$\begin{matrix}{{{G}_{d g} = 0 ∀ d ∉ {𝒟}_{{d}^{*}}}_{{G}_{{d}^{*} g} = 1}}_{} {Γ}_{g} - {\sum }_{d ∈ 𝒟} {λ}_{d} {G}_{d g} & Equation 14 \\ {𝒟}_{{d}^{*}} = \{ d ∈ 𝒟 ; {θ}_{d {d}^{*}} < ∞ \} & \end{matrix}$$

Term [symbol] _{d}*is the set of observations that may be grouped with observation d*, which can be referred to as its neighborhood. Since the lowest reduced cost hypothesis contains some d*∈D by solving Equation 14 for each d*∈D, the system 10 can solve Equation 6.

In step 64, the system 10 decreases a number of observations considered in the pricing sub-problems, particularly those with large numbers of observations. The system 10 performs step 64 by associating a unique rank r_{d} to each observation d∈ [symbol] , such that r_{d} increases with | [symbol] |, i.e., the more neighbors an observation has, the higher rank the system 10 assigns to it. To ensure that each observation has unique rank, the system 10 can break ties arbitrarily.

Given that d*is the lowest ranking observation in the hypothesis, the system 10 considers the set of observations subject to d∈{ [symbol] _{d}*∩{r_{d}≥r_{d}*}}, which is defined as [symbol] ^{*}_{d}*. The resultant pricing sub-problem is expressed by Equation 15, below:

$${Γ}_{g} - {\sum }_{d ∈ 𝒟} {λ}_{d} {G}_{d g} \qquad Equation 15$$

In step 66, the system 10 removes superfluous sub-problems. Specifically, the system 10 relaxes the constraint G_{d*g}=1 in Equation 15. It is noted that for any d₂∈ [symbol] ,d∈ [symbol] s.t. [symbol] _{d}*⊂D*d2 that the lowest reduced cost hypothesis over [symbol] *_{d2} has no greater reduced cost than that over D_{d}*. Neighborhood D*_{d*}can be referred to as being non-dominated if no d₂ ∈D exists s.t. D_{d}*⊂ [symbol] *d2. During pricing, the system 10 iterates over non-dominated neighborhoods. For a given non-dominated neighborhood D*_{d*}, the pricing sub-problem is expressed as Equation 16, below:

$${Γ}_{g} - {\sum }_{d ∈ D} {λ}_{d} {G}_{d g} \qquad Equation 16$$

In step 68, the system 10 performs exact and/or heuristic pricing. Specifically, the system 10 frames Equation 16 as a ILP, which the system 10 solves using a mixed integer linear programming (“MILP”) solver. Decision variables x, y are set as follows. Binary variable x_{d}=1 to indicate that d is included in the hypothesis being generated and otherwise set x_{d}=0. Variable γ_{d1d2}=1 to indicate that both d₁, d₂ are included in the hypothesis being generated and otherwise set γ_{d1d2}=0. The system 10 defines ε⁻={(d₁, d₂): θ_{d1d2}=∞} as the set containing pairs of observations that cannot be grouped together, and ε⁺={(d₁, d₂): θ_{d1d2}<∞} as the set containing pairs of observations that can be grouped together. Using these terms, the solution to Equation 16 as a MILP is expressed in Equation 17, below:

$${min}_{{{x}_{d} ∈ \{ 0 , 1 \}}_{{∀ d ∈ {𝒟}_{{d}^{*}}^{*}}_{y \geq 0}}} {\sum }_{d ∈ {𝒟}_{{d}^{*}}^{*}} - {λ}_{d} {x}_{d} + {\sum }_{{{d}_{1} ∈ {D}_{{d}^{*}}^{*}}_{{{d}_{2} ∈ {𝒟}_{{d}^{*}}^{*}}_{( {d}_{1} , {d}_{2} ) ∈ {ɛ}^{+}}}} {θ}_{{d}_{1} {d}_{2}} {y}_{{d}_{1} {d}_{2}} \qquad Equation 17$$

Equation 17 is subject to the following four constraints:

x_{d1}+x_{d2}≤1∀(d₁,d₂)∈ε⁻ Constraint 1:

γ_{d1d2}≤x_{d1}∀(d₁,d₂)∈ε⁺ Constraint 2:

γ_{d1d2}≤x_{d2}∀(d₁,d₂)∈ε⁺ Constraint 3:

x_{d1}+x_{d2}−γ_{d1d2}≤1∀(d₁,d₂)∈ε⁺ Constraint 4:

Equation 17 defines the reduced cost of the hypothesis being constructed. Constraint 1 enforces that pairs for which θ_{d1d2}=∞ are not included in a common hypothesis. Constraints 2-4 enforce that γ_{d1d2}=x_{d1xd2}. It is noted that since variable x is binary, variable y must also be binary so as to obey constraints 2-4. Thus, the system 10 does not need to explicitly enforce y to be binary.

It is noted that the system 10 solving Equation 16 using Equation 17 and constraints 1-4 for each non-dominated neighborhood can be too time intensive for some scenarios. This is because Equation 16 generalizes max-cut, which is NP-hard. Accordingly, the system 10 can use heuristic methods (e.g., heuristic pricing) to solve Equation 16. By using heuristic pricing in machine learning/computer vision, the system 10 decreases the computation time of pricing by decreasing the number of sub-problems solved, and solving those that are solved heuristically.

In early termination of pricing, it is noted that solving pricing (exactly or heuristically) over a limited subset of the sub-problems produces an approximate minimizer of Equation 6. The system 10 decreases the number of sub-problems solved during a given iteration of column generation as follows. The system 10 terminates pricing in a given iteration when M negative reduced cost hypothesis have been added to G in that iteration of column generation (M is a user defined constant; M=50 is used by way of example). This process can be referred to as partial pricing.

The system 10 can solve the sub-problems approximately (e.g., solve Equation 17 with constraints 1-4) using a quadratic pseudo-Boolean optimization with improve option (“QPBO-I”) method. It is noted that the use of heuristic pricing does not prohibit the exact solution of Equation 3. The system 10 can switch to exact pricing after heuristic pricing fails to find a negative reduced cost hypothesis in G.

Returning to step 36 of FIG. 2A, the system 10 performs entity resolution using the F-MWSP formulation by computing for Ξ_{dg}. Specifically, for any given g∈ Ĝ, the system 10 constructs Ξ_{dg} to satisfy Equation 10, which leads to efficient optimization. The system 10 rewrites ϵ+Γ_{g̅}(g, [symbol] ₛ)−Γ_{g} by plugging in the expressions for Γ_{g} in Equation 13, expressed below in Equation 18. The system 10 uses [symbol] _{g} to denote the subset of [symbol] for which G_{dg}=1.

$$ϵ + {\sum }_{{{d}_{1} ∈ {𝒟}_{g}}_{{d}_{2} ∈ {𝒟}_{g}}} - {θ}_{{d}_{1} {d}_{2}} max ( [ {d}_{1} ∈ {𝒟}_{s} ] , [ {d}_{2} ∈ {D}_{s} ] ) \qquad Equation 18$$

The system 10 bounds the components of Equation 18 as follows. For θ_{d1d2}<0, the system upper bounds −θ_{d1d2} max([d₁∈ [symbol] ₛ], [d₂∈ [symbol] ₛ]) with: −θ_{d1d2}([d₁∈ [symbol] ₛ]+[d₂∈ [symbol] ₛ]). For θ_{d1d2}>0, the system 10 upper bounds −θ_{d1d2} max([d₁∈ [symbol] ₛ], [d₂∈ [symbol] ₛ]) with: −(θ_{d1d2}/2) ([d₁∈ [symbol] ₛ]+[d₂∈ [symbol] ₛ]). The system then plugs the upper bounds into Equation 18, grouped by [d∈ [symbol] ₛ], and enforces non-negativity of the result. Equation 18≤ [symbol] [d∈ [symbol] ₛ]Ξ_{dg} where Ξ_{dg}=0 for d∉ [symbol] _{g}, is expressed in Equation 19, below:

$${Ξ}_{d g} = ϵ + max ( 0 , - {\sum }_{{d}_{1} ∈ {𝒟}_{g}} {θ}_{d {d}_{1}} ( 1 + [ {θ}_{d {d}_{1}} < 0 ] ) ) ∀ d ∈ {𝒟}_{g} \qquad Equation 19$$

Testing and analysis of the above systems and methods will now be discussed in greater detail. Specifically, the following will discuss different properties of the F-MWSP clustering algorithm and evaluate the performance scores on certain benchmark datasets. The classifier system 14 used an entity resolution library called Dedupe to perform blocking and scoring functionalities. Dedupe offers attribute type specific blocking rules and a ridge logistic regression algorithm as a default for scoring. However, the classifier system 14 can keep the domain of the dataset in mind, thus significantly boosting the performance of the clustering outcome.

To understand the benefits of F-MWSP clustering, it is helpful to first conduct an ablation study on a single dataset. The dataset chosen in this section is called patent_example and is available on the Dedupe library. Dataset patent_example is a labeled dataset listing the patent statistics of the Dutch innovators. It has 2379 entities and 102 clusters where the mean size of the cluster is 23. The dataset was split into two halves and the second half was set aside only to report the accuracies. The first half of the dataset that is visible to the learning algorithm from which approximately 1% of the total matches were randomly sampled and provided the classifier system 14 as a labeled data.

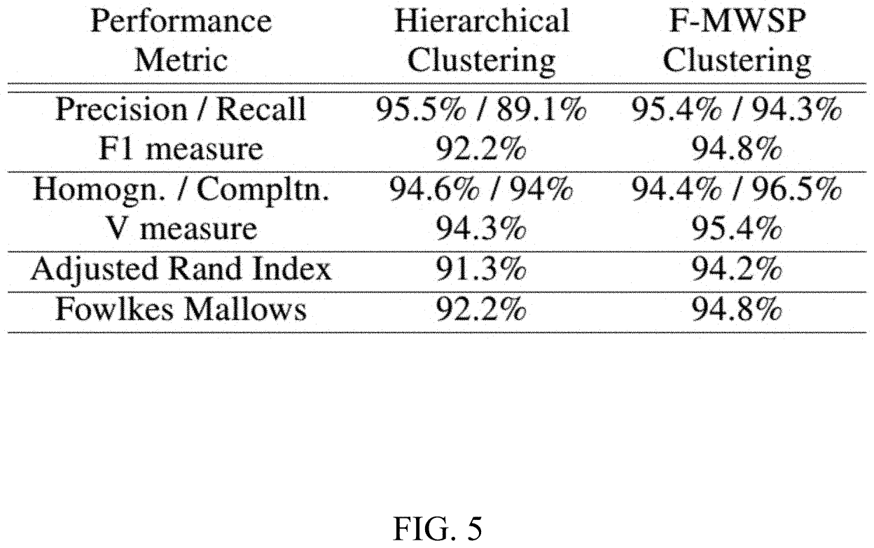

FIG. 5 is a table showing a comparison between the hierarchical clustering and the F-MWSP clustering of the present disclosure. As shown, the F-MWSP formulation clusters offer better performance over hierarchical clustering. The performance has been evaluated against standard clustering metrics.

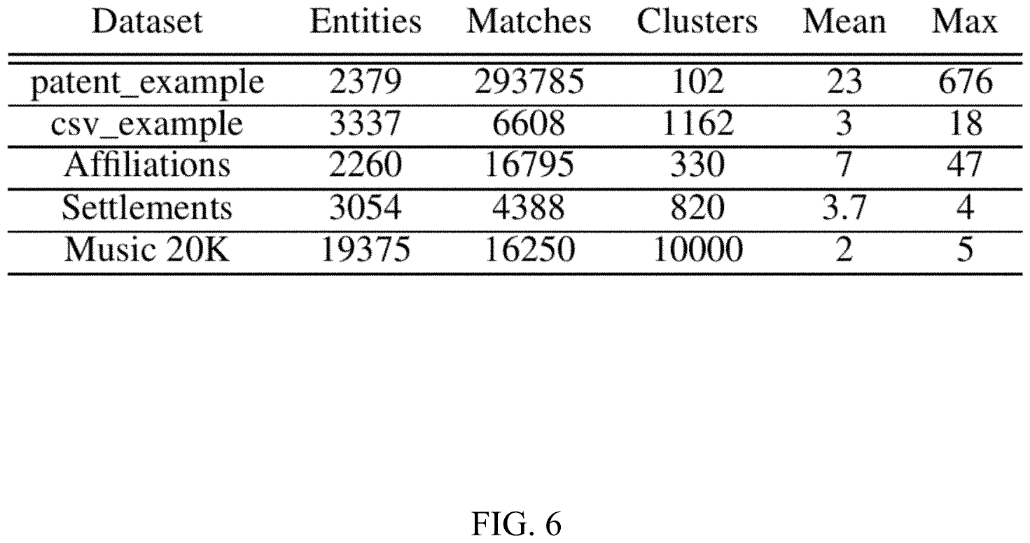

FIG. 6 is a table showing dataset statistics of the different datasets used in the experiments. Mean and Max denote the respective statistics over the cluster sizes.

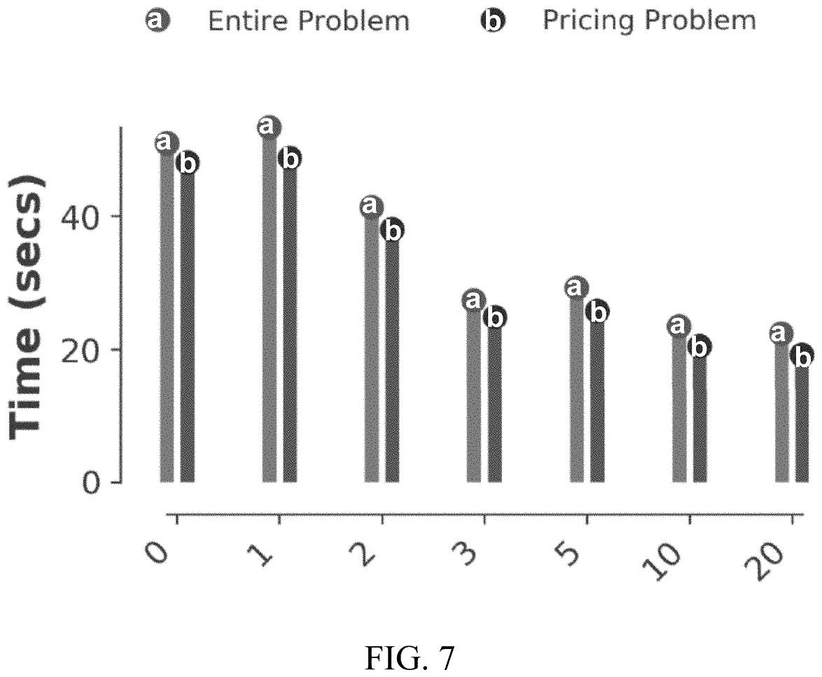

FIG. 7 is a graph showing speedups using F-DOIs. It is noted that the present system using the F-DOIs over the varying DOIs obtained at least a 20% speed up. Further, the computation time of the problem decreases as the number of thresholds (value of K) increases, with up to 60% speedup. As such, varying the number of thresholds (value of K) of the F-DOIs improves the convergence speed. Threshold value 0 corresponds to the varying DOIs.

The present system also provides tractable solutions to the pricing problem. Specifically, regarding solving pricing exactly or heuristically, exact pricing is often not feasible in entity resolution owing to the large neighborhoods of some sub-problems. However, the present system using the heuristic solver cut down the computation time by a large fraction. For example, dataset patent_example takes at least 1 hour for completion with the exact solver while with the heuristic solver it takes approximately 20 seconds.

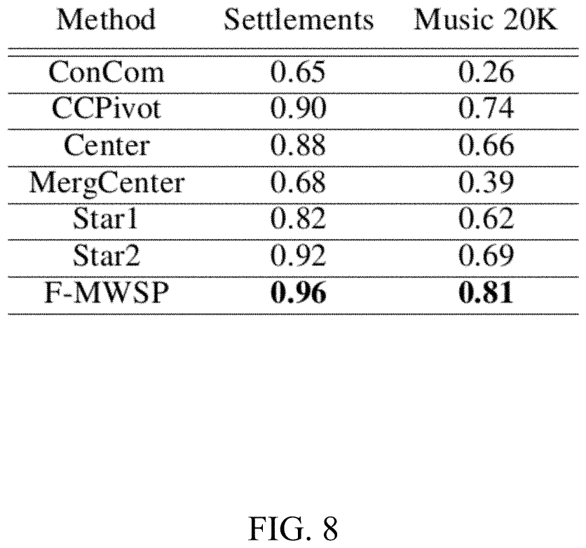

Experiments were also conducted with additional entity resolution benchmark datasets. Specifically, comparing to the csv_example dataset (which is available on Dedupe and akin to patent_example), the F-MWSP formulation achieves a higher F1 score of 95.2% against hierarchical clustering 94.4%, the default in Dedupe. FIG. 8 is a table showing results of the F-MWSP formulation (clustering) compared to prior art baselines on two benchmark datasets. As seen, the F-MWSP formulation obtained a higher F1 score over the prior art methods.

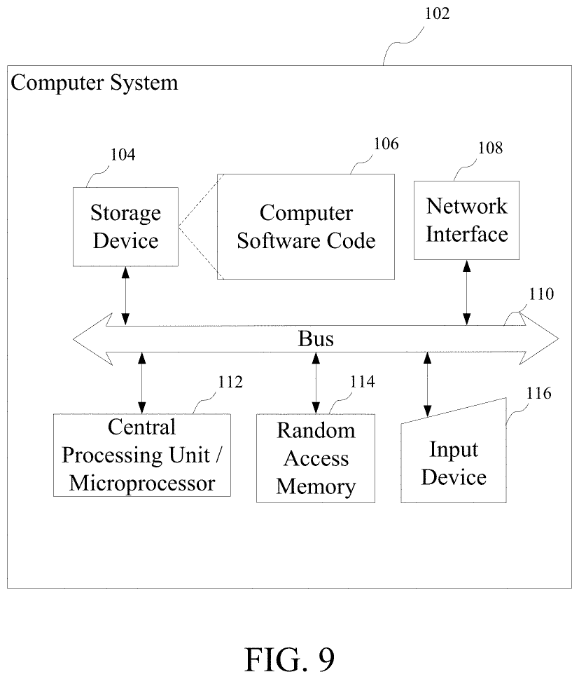

FIG. 9 is a diagram showing a hardware and software components of a computer system 102 on which the system of the present disclosure can be implemented. The computer system 102 can include a storage device 104, computer software code 106, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 102 could be a networked computer system, a personal computer, a server, a smart phone, tablet computer etc. It is noted that the server 102 need not be a networked server, and indeed, could be a stand-alone computer system.

The functionality provided by the present disclosure could be provided by computer software code 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single-core or multiple-core microprocessor of any suitable architecture that is capable of implementing and running the computer software code 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed:

1. A machine learning system for performing entity resolution comprising:
a memory; and
a processor in communication with the memory, the processor:
receiving a dataset of observations, the dataset being a structured table where each row represents an observation of a real world entity,
processing the dataset using a machine learning algorithm to:
(i) apply a blocking technique to the dataset by utilizing a least one attribute of the table to identify and generate a subset of pairs of observations of the dataset that could represent a same real world entity, and
(ii) generate a probability score for each pair of observations of the subset, the probability score being defined over a given pair of observations and denoting a probability that each pair is associated with a common entity in ground truth; and
processing the output of the machine learning algorithm using a flexible minimum weight set packing framework to:
(i) determine problem specific cost terms of a single hypothesis associated with the subset of pairs of observations, and
(ii) perform entity resolution by partitioning the subset of pairs of observations into hypotheses based on the cost terms.

2. The system of claim 1, wherein the processor utilizes the flexible minimum weight set packing framework to determine the problem specific cost terms by adding a bias to negative of the probability scores.

3. The system of claim 1, wherein the processor utilizes the flexible minimum weight set packing framework to determine a negative reduced cost of the single hypothesis.

4. The system of claim 3, wherein the processor utilizes the flexible minimum weight set packing framework to determine the negative reduced cost of the single hypothesis by
generating a set of pricing sub-problems, each pricing sub-problem being defined over the subset of pairs of observations,
decreasing a number of pairs of observations considered in each pricing sub-problem,
removing superfluous pricing sub-problems to generate a subset of pricing sub-problems, and
performing at least one of exact pricing or heuristic pricing on the subset of pricing sub-problems.

5. The system of claim 1 wherein the dataset of observations is indicative of a plurality of records, each record being associated with a subset of fields including a name, a social security number, and a phone number.

6. The system of claim 1, wherein the machine learning algorithm is trained to distinguish between pairs of observations of the subset that are or are not associated with the common entity in ground truth based on a labeled data subset.

7. A machine learning method for performing entity resolution, comprising the steps of:
receiving a dataset of observations, the dataset being a structured table where each row represents an observation of a real world entity,
applying, via a machine learning algorithm, a blocking technique to the dataset by utilizing a least one attribute of the table to identify and generate a subset of pairs of observations of the dataset that could represent a same real world entity,
generating, via the machine learning algorithm, a probability score for each pair of observations of the subset, the probability score being defined over a given pair of observations and denoting a probability that each pair is associated with a common entity in ground truth, and
determining, via a flexible minimum weight set packing framework, problem specific cost terms of a single hypothesis associated with the subset of pairs of observations, and
performing, via the flexible minimum weight set packing framework, entity resolution by partitioning the subset of pairs of observations into hypotheses based on the cost terms.

8. The method of claim 7, further comprising the step of determining, via the flexible minimum weight set packing framework, the problem specific cost terms by adding a bias to negative of the probability scores.

9. The method of claim 7, further comprising the step of determining, via the flexible minimum weight set packing framework, a negative reduced cost of the single hypothesis.

10. The method of claim 9, further comprising the steps of determining the negative reduced cost of the single hypothesis by
generating a set of pricing sub-problems, each pricing sub-problem being defined over the subset of pairs of observations,
decreasing a number of pairs of observations considered in each pricing sub-problem, removing superfluous pricing sub-problems to generate a subset of pricing sub-problems, and
performing at least one of exact pricing or heuristic pricing on the subset of pricing sub-problems.

11. The method of claim 7, wherein the dataset of observations is indicative of a plurality of records, each record being associated with a subset of fields including a name, a social security number, and a phone number.

12. The method of claim 7, further comprising the step of training the machine learning algorithm to distinguish between pairs of observations of the subset that are or are not associated with the common entity in ground truth based on a labeled data subset.

13. A non-transitory computer readable medium having machine learning instructions stored thereon for performing entity resolution which, when executed by a processor, causes the processor to carry out the steps of:
receiving a dataset of observations, the dataset being a structured table where each row represents an observation of a real world entity,
applying, via a machine learning algorithm, a blocking technique to the dataset by utilizing a least one attribute of the table to identify and generate a subset of pairs of observations of the dataset that could represent a same real world entity,
generating, via the machine learning algorithm, a probability score for each pair of observations of the subset, the probability score being defined over a given pair of observations and denoting a probability that each pair is associated with a common entity in ground truth, and
determining, via a flexible minimum weight set packing framework, problem specific cost terms of a single hypothesis associated with the subset of pairs of observations, and
performing, via the flexible minimum weight set packing framework, entity resolution by partitioning the subset of pairs of observations into hypotheses based on the cost terms.

14. The non-transitory computer readable medium of claim 13, the processor further carrying out the step of determining, via the flexible minimum weight set packing framework, the problem specific cost terms by adding a bias to negative of the probability scores.

15. The non-transitory computer readable medium of claim 13, the processor further carrying out the step of determining, via the flexible minimum weight set packing framework, a negative reduced cost of the single hypothesis.

16. The non-transitory computer readable medium of claim 15, the processor determining the negative reduced cost of the single hypothesis by further carrying out the steps of
generating a set of pricing sub-problems, each pricing sub-problem being defined over the subset of pairs of observations,
decreasing a number of pairs of observations considered in each pricing sub-problem,
removing superfluous pricing sub-problems to generate a subset of pricing sub-problems, and
performing at least one of exact pricing or heuristic pricing on the subset of pricing sub-problems.

17. The non-transitory computer readable medium of claim 13, wherein the dataset of observations is indicative of a plurality of records, each record being associated with a subset of fields including a name, a social security number, and a phone number.

18. The non-transitory computer readable medium of claim 13, the processor further carrying out the step of training the machine learning algorithm to distinguish between pairs of observations of the subset that are or are not associated with the common entity in ground truth based on a labeled data subset.
